(19) United States
(12) Patent Application Publication
(10) Pub. No.: US 2013/0313363 A1
(43) Pub. Date: Nov. 28, 2013

(54) Surface Structure on a Ground Surface for Accelerating Decay of Wake Turbulence in the Short Final of an Approach to a Runway

(71) Applicant: Frank Holzapfel, Utting (DE)

(72) Inventor: Frank Holzapfel, Utting (DE)

(73) Assignee: DEUTSCHES ZENTRUM FÜR LUFT- UND RAUMFAHRT E.V., Köln (DE)

(21) Appl. No.: 13/982,374

(22) PCT Filed: Jan. 23, 2012
(86) PCT No.: PCT/DE2012/000051

§ 371 Date: Jul. 29, 2013

(30) Foreign Application Priority Data
Feb. 2, 2011 (DE) 102011010147.0

(51) Int. Cl. B64F 1/00

(52) U.S. Cl. CPC B64F 1/00
USPC 244/114 R

(57) ABSTRACT

The invention relates to a surface structure on a ground surface (106), located in the short final of an approach to a runway (101), with an associated start (104) of the runway (101) and a runway longitudinal axis (102). In order to attain accelerated decay of wake turbulence produced by an approaching aircraft, the surface structure has according to the invention a multiplicity of separate elevations (105) with an elevation height (h) ranging from 0.25-10 m, in particular from 1-5 m, wherein the individual elevations (105) have a spacing (a) between them, ranging from 1-600 m, 1-400 m, 1-200 m, 1-100 m, 1-50 m, 1-25 m, 1-15 m, 1-10 m, or in particular 2-8 m.

The invention relates to a surface structure on a ground surface, located in the short final of an approach to a runway, with an associated start of the runway (runway threshold) and a runway longitudinal axis, and which is used to attain accelerated decay of wake turbulence generated by an approaching aircraft. The term “short final” refers to the last section of the approach to a runway. It is essential in the present case that, in this section of the approach, an approaching aircraft continuously approaches the ground until the landing, and in the process reaches flight altitudes above ground which are so small that the wake turbulence generated by the aircraft can interact with the surface of the earth.

Worldwide, air traffic has been growing continuously for years at a rate of approximately 5% per year. By the year 2025, passenger air traffic will have doubled according to current forecasts. More and more airports are reaching their capacity limits. It is known that the number of flight movements on a landing or takeoff runway is limited on a time basis due to predetermined safety separations between aircraft that are approaching or taking off. These safety separations must be complied with, because, due to the updraft generated on the wings of flying aircraft, two strong oppositely rotating vortexes form, which can be dangerous for aircraft that follow. These two vortices in the wake of the aircraft are also referred to as “wake turbulence” in English, the vortex intensities of which are particularly strong during takeoff and landing, owing to the low flying speed and to the aircraft configuration (landing gear deployed) in this flight phase.

If an aircraft flies into this spatially delimited wake turbulence of an aircraft flying ahead of it, then extraordinarily large additional aerodynamic forces and moments can act on the aircraft, which in the worst case cannot be compensated for by the aircraft flying into the wake turbulence, and which can lead to uncontrolled flight positions or to structural overloading of the aircraft. In order to largely prevent the risk of such dangerous events, minimum longitudinal stagger spacings between two aircraft flying one after the other have already been required for many years, in the field of controlled passenger air traffic.

Currently, these requirements are based on the admissible maximum weight (MTOW=Maximum Take Off Weight) of the aircraft involved, and they take into account no other effects that influence the generation and the weakening of the turbulence. Thus, these safety spacings limit the maximum possible takeoff and landing frequencies of airports and, in the case of high traffic volumes, they lead to capacity bottlenecks, and thus to holding patterns and delays.

Since the stagger spacings that have to be maintained limit the scarce capacities of the air space and of passenger airports, special attention has been paid for some years to the generation and the effect of wake turbulence on subsequent aircraft. The goal of varied research in Europe and in the USA has been to investigate the phenomenon of turbulence generation and of wake turbulence so that, in the end, the longitudinal stagger spacing operations that have to be carried out for safety reasons can be handled more flexibly and in particular can be reduced. At this time, research on this topic can be divided into three areas: turbulence prevention, turbulence compatibility, and turbulence detection or turbulence forecasting.

Turbulence prevention is based on developing aircraft that have more advantageous turbulence characteristics, so that turbulence formation is already reduced during the generation, for example, by changes in the construction of the aircraft itself. Thus it is known that aircraft wake turbulence can be weakened by the generation and interaction of multi-vortex systems. Aircraft constructions that potentially generate such multi-vortex systems themselves have been disclosed, for example, in the patents DE 199 09 190 A1 or U.S. Pat. No. 6,082,679 A. The improvement of the turbulence compatibility of aircraft, on the other hand, pertains to possibilities of designing aircraft in such a manner that the flight safety of an aircraft is still ensured in spite of flying into wake turbulence, i.e., so that the structural design of the aircraft is such that it withstands without damage a flight into or through wake turbulence, and in such a manner that the control design enables corresponding compensation maneuvers when flying into or through wake turbulence. Turbulence prediction and turbulence detection are based on the investigation of the physical processes of formation, transport and decay of turbulence in the earth's atmosphere. Today, these physical processes are largely known. Methods derived therefrom for evaluating the turbulence behavior depending on current meteorological parameters today allow a sufficiently good prediction of turbulence. Now, for several years, wake turbulence warning systems have been developed based on current turbulence measurements or the knowledge of the physics of turbulence, systems that should make it possible to dynamically adapt the spacings between aircraft that are landing or taking off, under suitable atmospheric conditions. This means that, using said wake turbulence warning systems, it should be possible to dynamically shorten or increase the aircraft stagger spacing, in compliance with the safety requirements, and depending on current, measured atmospheric parameters.

It is known that at high flight altitudes where the wake turbulence of an aircraft is not influenced by the ground, the aircraft longitudinal stagger spacing in a flight corridor can be reduced if at least one of the following criteria is met:
the vortices sink under the flight corridor,
the vortices drift to the side out of the flight corridor,
owing to the current environmental turbulence or thermal stratification, the vortices quickly decay and consequently they weaken sufficiently rapidly, or
predicted turbulence regions are avoided by alternative/modified flight routes.

The presence of the above criteria can be determined with sufficient accuracy by corresponding atmospheric measurements, so that a dynamic aircraft stagger spacing at high flight altitudes appears possible in principle. However, at low flight altitudes, the situation is different, because, at low flight altitudes, effects of the ground on wake turbulence cannot be left out of consideration, and the use of the above described criteria is not possible without difficulties.

Thus, it is known that most incidents of aircraft flying into wake turbulence occur at takeoff and landing within the lowermost 100 m above ground, since wake turbulence vortices at those altitudes, in contrast to high flight altitudes, do not sink below the landing or takeoff corridor; on the contrary, they can even rise again due to interaction with the ground. Weak cross winds near the ground are compensated by the self-induced lateral transport of the windward vortex, so that the vortices leave the landing or takeoff corridor reliably only in the case of very strong cross winds. In addition, the contribution of atmospheric turbulence and thermal stratification to the decay of turbulence near the ground is only weakly pronounced. Moreover, flying into such turbulence at low flight altitudes is considerably more dangerous than at high flight altitudes, since the available flight space for compensatory flight maneuvers at low flight altitude is considerably limited due to the proximity to the ground. In addition, due to the low aircraft speed, the large angle of attack of the airfoils of the aircraft, and the deployed landing gear, the turbulence intensity is highest during the final approach, so that the required flight maneuvers needed to compensate for the effects of wake turbulence on an aircraft take up a larger air space than at high flight altitudes. If uncontrolled flight positions occur here, they can conceivably not be compensated for in extreme cases in the available air space, resulting in contact with the ground or a crash.

Accordingly, it is disadvantageous that a dynamic aircraft stagger spacing at low flight altitudes is frequently not possible on the basis of the above-indicated criteria for high flight altitudes. This radically limits the maximum possible capacity of flight movements on a landing or takeoff runway.

The problem of the invention is to increase the capacity, which is limited by wake turbulence, of flight movements on the landing or takeoff runway.

The invention results from the features of the independent claims. Advantageous variants and designs are the subject matter of the dependent claims. Further characteristics, application possibilities, and advantages of the invention result from the following description and from the explanation of embodiment examples of the invention that are represented in the figures.

The problem is solved according to Claim 1 with a surface structure on a ground surface located in the short final of an approach to a runway with an associated runway threshold and with a runway longitudinal axis, and/or in the takeoff area directly following the approach end of the runway. The latter situation arises naturally, since a runway can typically be approached for landing from the two possible directions, depending on the current wind situation, so that the surface structuring according to the invention is preferably present in the two directions of approach to the runway. The surface structure according to the invention is characterized in that a multiplicity of separate elevations with an elevation height in the range of 0.25-10 m, in particular 1-5 m, is present on this ground surface, wherein the individual elevations are separated from each other by a spacing in the range of 1-600 m, 1-400 m, 1-200 m, 1-100 m, 1-50 m, 1-25 m, 1-15 m, 1-10 m, or particularly 2-8 m.

The invention is based on the idea of reliably attaining an acceleration of the decay of wake turbulence (primary vortex) generated by an aircraft near the ground, by a modification according to the invention of the surface structure of the ground surface in the short final of an approach to a runway, and of thus largely preventing the above indicated disadvantageous effects of the ground on turbulence. Thus, it is proposed for the first time to accelerate the decay of wake turbulence near the ground by passive measures on the ground. In the process, as the wake turbulence of an aircraft that is landing or taking off approaches the ground surface that has been modified according to the invention, a shearing layer forms, from which secondary vortices separate. These secondary vortices interact with the primary vortices of wake turbulence in such a manner that the decay of the primary vortices is accelerated. Due to the surface structure according to the invention, the generation of the secondary vortices in the flight direction is modulated. As a result, the secondary vortices wrap around the primary turbulences, thus generating instabilities that deform the primary vortices and lead to the accelerated decay of wake turbulence. The deformation of the primary vortices already decreases their effect on landing aircraft, because, as a result, the duration of exposure to adverse forces and moments is decreased.

Overall, with the surface structure according to the invention, the decay of the primary vortices can be induced and accelerated by modulated secondary vortices. The safety of regular landings and takeoffs and the capacity for flight movements on a takeoff and landing runway are consequently increased.

Here, the surface structure according to the invention acts in a passive manner on the near-ground sinking of wake turbulence generated during the landing or takeoff of aircraft, the manufacture of the surface structure according to the invention is cost effective, and the associated maintenance costs are low. The turbulence-dissolving effect of the surface structure according to the invention is largely independent of the given environmental conditions.

The elevations according to the invention can be arranged statistically or deterministically, particularly in periodic patterns, so that targeted instabilities of the wake turbulence can be excited on different scales, such as, for example, the short-term instability, the long-term stability, the Crow instability, as well as instabilities of four-vortex systems. The same also applies to the distribution of the elevation heights. The latter can also vary statistically or deterministically, and in particular periodically. It is assumed here that the ground surface affected by the manufacture of the surface structure according to the invention is largely flat, and thus has a nearly uniform ground level elevation, for example, in m NN [meters above standard elevation zero]. The elevation height here gives the vertical extent of the respective elevation above ground level elevation.

In order to excite modulated secondary vortices or instabilities of wake turbulence on the above-mentioned different scales, the elevations have to be arranged according to the invention with a spacing from each other in the range of 1-600 m, 1-400 m, 1-200 m, 1-100 m, 1-50 m, 1-25 m, 1-15 m, 1-10 m, or particularly 2-8 m. Moreover, the elevation heights should be selected here, according to the invention, in the range of 0.25-10 m, in particular 1-5 m.

Since the turbulence characteristics generated by aircraft are known to depend on the weight of the aircraft and the wingspan, the spacings of the elevations as well as the elevation heights required to generate the mentioned instabilities are different depending on aircraft type. For a landing and takeoff runway used by different aircraft types, the arrangement of the elevations as well as their elevation heights can be optimized, for example, for a selection of aircraft types. It is preferable for the types to relate to the largest landing aircraft, because they are the most hazardous for smaller aircraft that follow them.

Naturally, the elevations, in terms of their position and elevation heights, are designed in such a manner that the requirements and specifications of the authorities with regard to absence of obstacles in the landing and takeoff area are always met. The elevations can be designed as mounds of earth, as suitable plantings with bushes, trees, etc., and/or as artificial objects of any type, for example, as foam material sculptures or resilient walls. Here, it is particularly preferable to use soft, resilient construction materials, such as, for example, foam material, styropor, etc., which, in the case of contact with the ground, oppose only a very small resistance to an aircraft, so that, in the case of contact of an aircraft with the ground, the elevations generate substantially no additional sources of accidents.

A preferred variant of the surface structure according to the invention is characterized in that the ground surface with the surface structure has the following length and width dimensions: length dimension in the range of 0.5-2.5 km, 1.5-2.2 km, particularly 1.8-2.0 km; width dimension in the range of 25-1000 m, 50-250 m, 75-125 m, wherein the ground surface is preferably a rectangular area. The length dimension of the concerned ground surface in the final approach depends on the smallest approach angle of an approach procedure provided for the runway. The flatter this angle of approach is, the greater the required longitudinal dimension is. The width dimension depends particularly on the weight and the wingspan of the largest landing aircraft. If only one runway is present (no parallel runways), an approach angle of 3° is assumed, and aircraft such as the Airbus A380 or Boeing 747, for example, are taken into consideration, then a ground surface structured according to the invention with a length dimension of 1 NM (=1.852 km) and a width dimension of: ±50 to ±75 m relative to the runway longitudinal axis produces a sufficiently rapid decay of wake turbulence, so that the longitudinal stagger spacing of the landing aircraft can be reduced considerably compared to today.

The longitudinal axis of the ground surface is preferably identical to the runway longitudinal axis. The ground surface is arranged in the approach direction preferably immediately before the runway threshold. In the case of parallel landing or takeoff runways that are arranged closely adjacent to each other and cannot be operated independently, it is recommended to also provide the ground surface between the landing or takeoff runways in the area of their respective final portion with the surface structure according to the invention. Thus, wake turbulence vortexes that have drifted due to a cross wind can disintegrate or at least weaken significantly before they reach the approach area of the corresponding parallel runway.

It is particularly preferable to arrange the elevations with their longitudinal axis parallel to the runway longitudinal axis, since, in this case, the aerodynamically active area of the elevations also corresponds to the largest front area, and thus produces the largest effect.

A preferred variant of the surface structure according to the invention is characterized in that the elevations are arranged on both sides of the runway longitudinal axis in each case in at least one row parallel to the runway longitudinal axis. For the excitation of the instabilities, the elevation heights of the elevations along the runway longitudinal direction vary in a deterministic manner in accordance with a predetermined, in particular sinusoidal, function. Naturally, other variations are also conceivable. In the case of the sinusoidal variation, the wavelengths of the sinusoidal variations of the elevation heights are preferably in the range of 1-600 m, and particularly in the range of 300-500 m. In particular, the wavelength is 400 m±15 m, wherein the elevation height is varied up to a maximum elevation height of 5 m.

Additional advantages, characteristics and details result from the following description in which an embodiment example is described in detail in reference to the drawings. Features that are described and/or represented in the drawing constitute themselves or in any reasonable combination the subject matter of the invention, possibly also independently of the claims, and in particular they can also be an additional subject matter of one or more separate applications. Identical, similar and/or functionally equivalent parts are provided with identical reference numerals.

In the drawings:

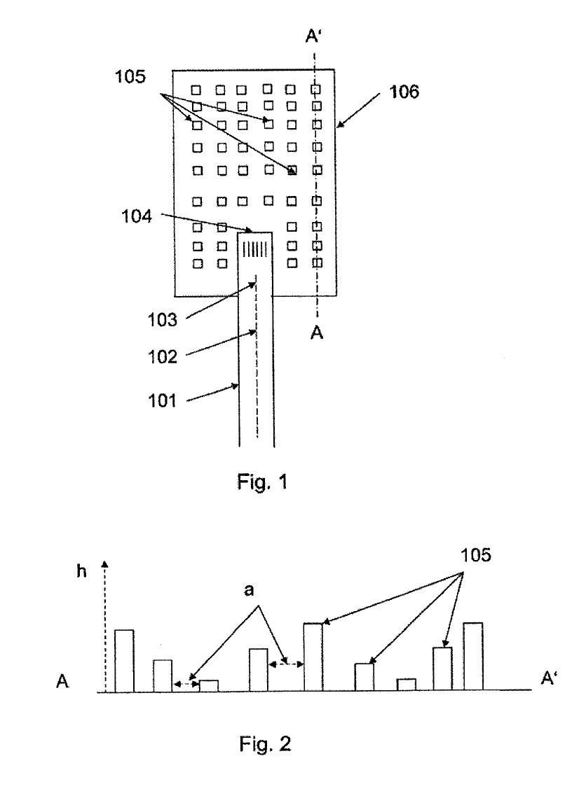

FIG. 1 shows a diagrammatic representation of a runway with a ground surface surrounding the landing head, having a surface structure according to the invention; and

FIG. 2 shows a vertical section along the section line A-A′ of FIG. 1.

FIG. 1 shows a diagrammatic representation of a runway 101 with a ground surface 106 surrounding the runway start 104 (runway head), which has a surface structure according to the invention. The runway 101 with the runway start 104 and the runway longitudinal axis 102 has a touchdown zone 103 which indicates the area in which planes typically touch down on the runway 101 with their wheels during the landing. The approach to the diagrammatically represented runway 101 occurs in the present case along the runway longitudinal axis from the top edge of the figure in the direction of the touchdown zone 103. Here, the short final of the approach ends at the runway start 104.

It is known that the airfoils of a flying aircraft generate edge vortices (primary vortices of wake turbulence) at the ends of the wings. It is only after the landing, i.e., when all the wheels of the vehicle have touched down, that the vortex production is strongly reduced or almost completely absent. For this reason, it is advantageous to extend the ground surface structured according to the invention along the runway 106 over a distance such that the touchdown zone 103 of the runway 101 is surrounded on the side by the surface structured according to the invention. Thus, an accelerated decay of wake turbulence generated by the aircraft takes place up to the landing point.

In the depicted embodiment example, the ground surface 106 has a surface structure according to the invention with a multiplicity of separate elevations 105 having an elevation height h in the range of 1-5 m, wherein the separate elevations are separated from each other by a spacing of 2-8 m. The size conditions represented in FIG. 1 are, however, not true to scale.

In the present case, the elevations 105 are arranged in rows parallel to the runway longitudinal axis 102. Moreover, the elevations 105 are implemented in terms of their arrangement and their elevation height h in such a manner that all the requirements of the authorities are satisfied, particularly the requirements pertaining to areas that are free of obstacles in the approach sector.

Although the elevations 105 are represented in the present case in the form of squares, this should not lead to any conclusion regarding their external shape. Rather, the elevations 105 are preferably designed as wall elements whose longitudinal axes are oriented parallel to the runway longitudinal axis 102. Moreover, the elevations 105 are preferably manufactured from a foam material or styropor.

Moreover, a cutting line A-A′ can be seen in FIG. 1, along which the vertical section in FIG. 2 is represented.

FIG. 2 shows, not to scale, the vertical section along the cutting line A-A′ of FIG. 1. The cutting line A-A′ represents the ground surface which, in the present embodiment example, is flat in the entire ground surface area 106, i.e., it has one elevation height. The elevations 105 confer a surface structure according to the invention to the ground surface 106. It can be seen that the individual elevations 105 have different elevation heights h, which in the present case vary approximately sinusoidally along the runway longitudinal direction 102. Here, the spacings a of the individual elevations 105 are not constant in the present case, instead they also vary. The spacings a as well as the elevation heights h are selected depending on the largest plane that approaches this runway 101 for landing.

For example, to excite the Crow instability, which typically has the wavelength of 6-7, particularly 6.8 times the wingspan of a plane, one gets an optimal wavelength of 438 meters for a Boeing 747 with a wingspan of 64.4 meters.

1. A surface structure of a ground surface, which is located in a short final of an approach to a runway, with an associated runway start and a runway longitudinal axis, the surface structure comprising a multiplicity of separate elevations with an elevation height (h) in a range of 0.25 m-10 m, wherein separate elevations have a spacing (a) between them in a range of 1 m-600 m.

2. The surface structure according to claim 1, wherein the ground surface comprising the surface structure has a length dimension in a range of 0.5 km-2.5 km and a width dimension in a range of 25 m-1000 m.

3. The surface structure according to claim 1, wherein a longitudinal axis of the ground surface is identical to the runway longitudinal axis, and the ground surface in an approach direction is arranged substantially before the associated runway start of the runway.

4. The surface structure according to claim 1, wherein the elevations vary statistically with regard to their arrangement, elevation height (h) or spacing (a).

5. The surface structure according to claim 1, wherein the elevations are formed as mounds of earth, bushes, trees or as artificial objects.

6. The surface structure according to claim 1, wherein the elevations are arranged with their respective longitudinal axis parallel to the runway longitudinal axis.

7. The surface structure according to claim 1, wherein the elevations are arranged on both sides relative to the runway longitudinal axis in each case in at least one row parallel to the runway longitudinal axis.

7. The surface structure according to claim 1, wherein the elevation height (h) of the elevations varies sinusoidally along the runway longitudinal axis.

8. The surface structure according to claim 7, wherein a wavelength of a sinusoidal variation of the elevation height (h) of the elevations is in a range of 1 m-600 m.

9. The surface structure according to claim 8, wherein the wavelength is 400 m±15 m, wherein the elevation height (h) varies up to a maximum elevation height (h) of 5 m.

10. The surface structure according to claim 7, wherein the wavelength of the sinusoidal variation is in a range of 300 m-500 m.

11. The surface structure according to claim 1, wherein the elevation height (h) is in a range of 1 m-5 m.

12. The surface structure according to claim 1, wherein the spacing (a) between the separate elevations is in a range selected from the group consisting of: 1 m-400 m; 1 m-200 m; 1 m-100 m; 1 m-50 m; 1 m-25 m; 1 m-15 m; 1 m-10 m; and 2 m-8 m.

13. The surface structure according to claim 1, wherein the ground surface comprising the surface structure has a length dimension in a range of 1.5 km-2.2 km, or 1.8 km-2.0 km.

14. The surface structure according to claim 1, wherein the ground surface comprising the surface structure has a width dimension in a range of 50 m-250 m, or 75 m-125 m.

15. The surface structure according to claim 1, wherein the ground surface is a rectangular area.
